(19) United States
(12) Patent Application Publication
(10) Pub. No.: US 2019/0034619 A1
(43) Pub. Date: Jan. 31, 2019

(54) Smart Password Protection (SPP)

(71) Applicant: WISAM KHALID IBRAHIM, Doha (QA)

(72) Inventor: WISAM KHALID IBRAHIM, Doha (QA)

(21) Appl. No.: 15/659,749

(22) Filed: Jul. 26, 2017

(51) Int. Cl. G06F 21/45

(52) U.S. Cl. CPC G06F 21/45

(57) ABSTRACT

Protecting all user's passwords around the world by giving them the ability to embed the password within any random text or numbers when they are trying to enter password, which will hide completely their passwords from any thief or person looking at them. A search software will find the password in between the text and numbers entered and as soon as it finds it, the process will continue for login.

### § BACKGROUND OF THE INVENTION

I tried to make a ciphering program then I thought to make a secure login for the password of that program, and the problem appears that when a user try to enter his password, people around that user can see the password by simply looking at keyboard. Then I found the solution to this problem (Invention), and it appears that this Invention is applicable to any software or any software system that require password for login like for example (Credit/Debit Cards, Websites login, Database login, Emails, Secured files . . . etc.).

### § BRIEF SUMMARY OF THE INVENTION

A method that (protects user password and any credit/debit card password) from (thieves or people eyes watching that user) by giving user ability to write random text or numbers so they will be no longer able to know what password were used, this method can be applied to any software or any software system around the world that require password.

### § BRIEF DESCRIPTION OF THE SEVERAL VIEWS OF THE DRAWINGS

FIG. 1) shows the normal process (Before invention)

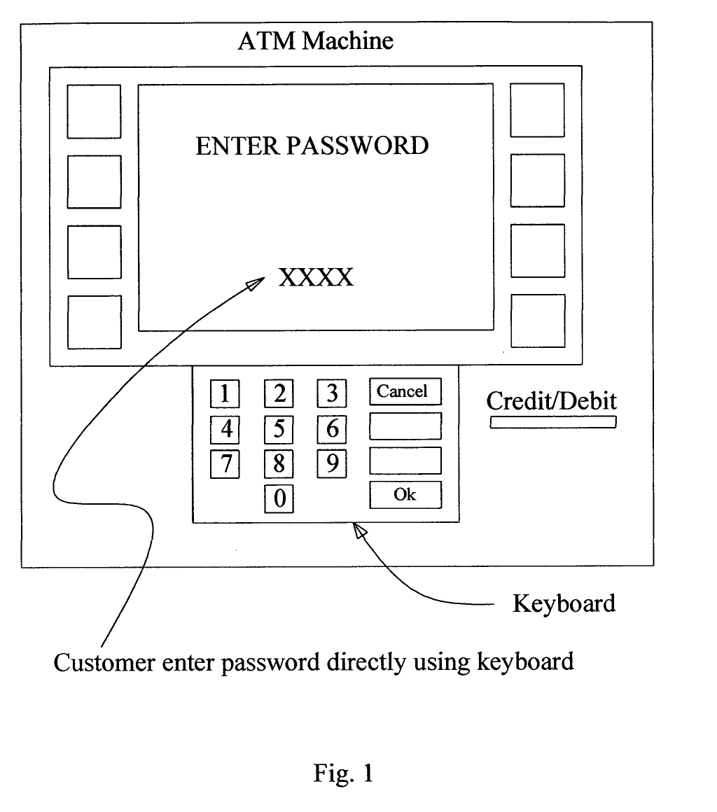

FIG. 2) shows one example of thieves' way to steal passwords of Credit/Debit cards

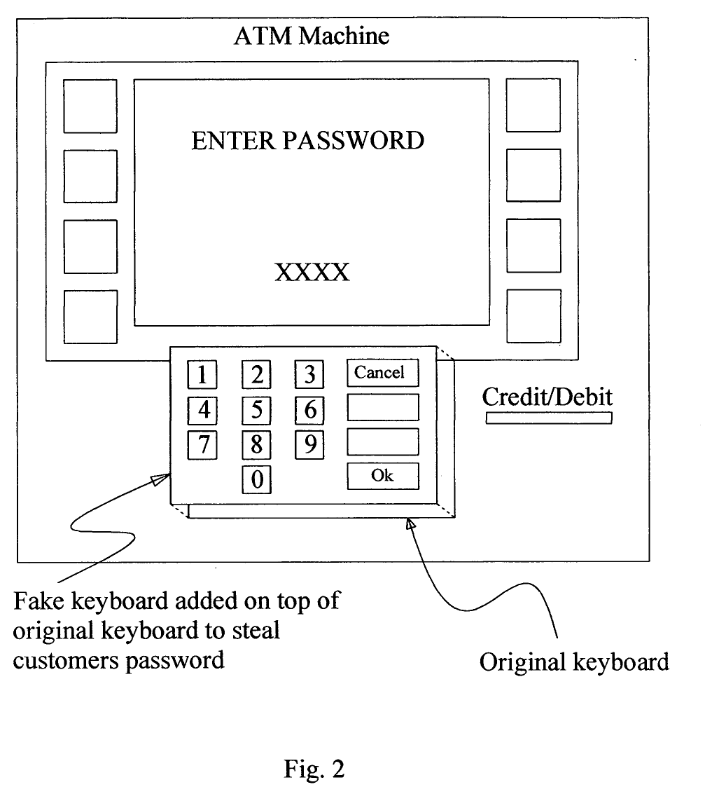

FIG. 3) shows the process (After invention)

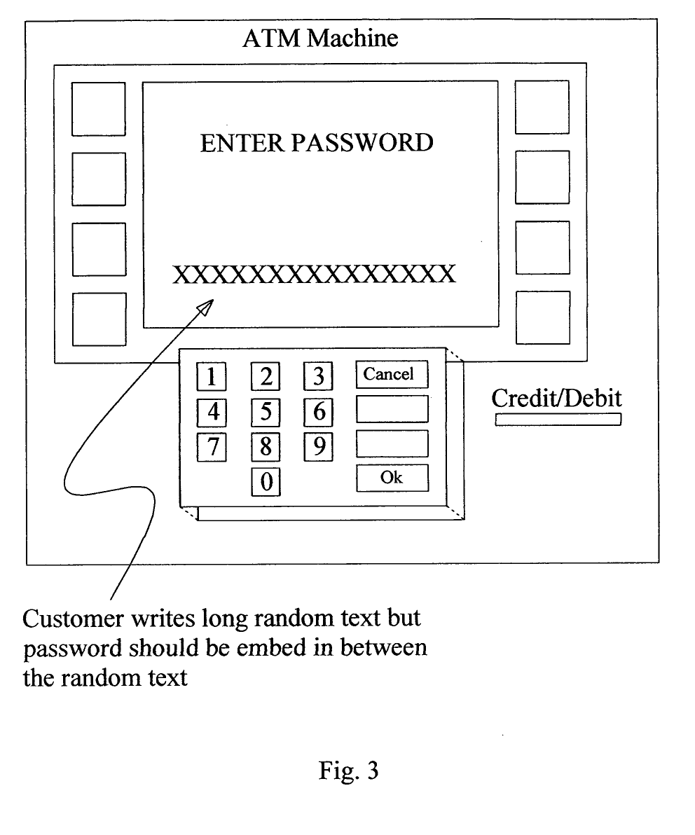

FIG. 4) shows the general workflow chart for the invention

### § DETAILED DESCRIPTION OF THE INVENTION

Normally for any login to software system a user will be asked to enter password and when he enters the password it is displayed immediately as stars (****) or (xxxx) depend on that software system to protects the password from people eyes around that user.

As shown in figure number (1)

In addition, it is very easy for any thief or anyone looking to know the password, as shown in figure number (2) one of thieves way to steal password.

The Invented method will allow user to write any random text or numbers when he/she trying to enter the password but the password should be embed within this random text or numbers, then a software search routine programmed inside that software system will start search to find the password in between the text or numbers entered.

For example:

If the password is (2017), the user can embed (2017) within any random text or numbers like embed password is sandwiched between numbers (13246123201768), or (475201768749598), or (987562154682017) or embed password scattered (14520879137924), or In any other way the user like, then a search software will start searching the input text, starting from left to right or from right to left or in any other way trying to find password in between the input text, and as soon as it finds the password then the login process continue.

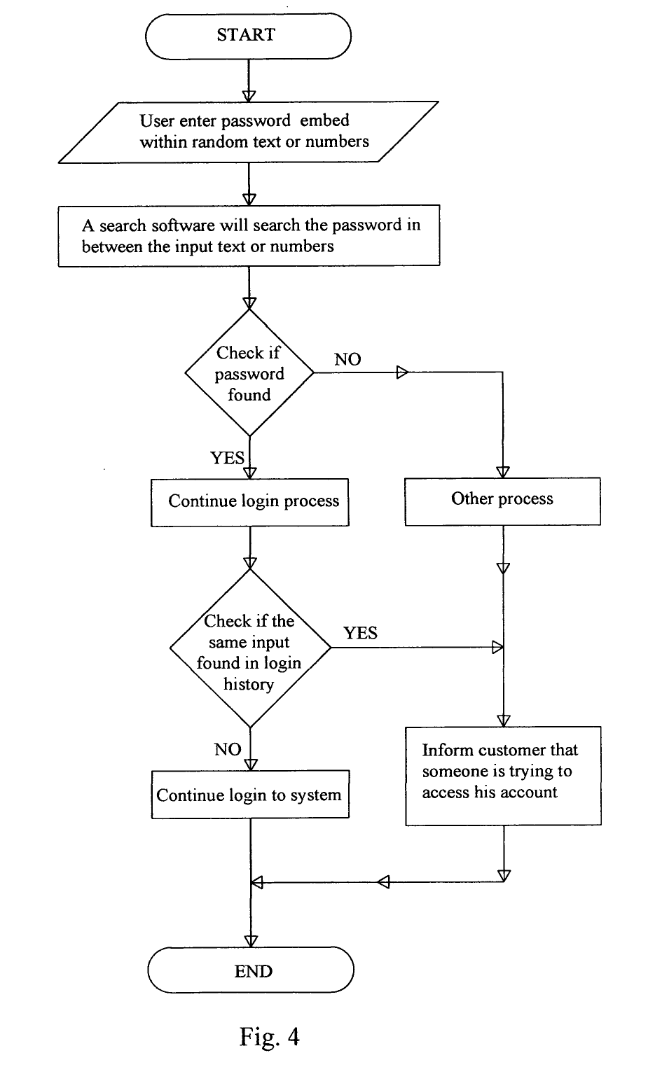

As shown in figures number (3) and FIG. 4) the workflow chart

In addition, of course there should be limit to numbers and text characters entered.

In this way, no thieves or anyone around that user who even looking at the keys or keyboard will be able to know the password.

This method will protects all users' passwords completely around the world from any thief or person copying or trying to look at the password.

1- Searching and finding embed password in between the text or numbers entered for any software or any software system that require password.

2- Searching and finding embed ciphered password in between the text or numbers entered for any software or any software system that require ciphered password.
